(19) United States
(12) Patent Application Publication
(10) Pub. No.: US 2015/0061472 A1
(43) Pub. Date: Mar. 5, 2015

(54) SYNCHRONOUS ELECTRIC MACHINES

(71) Applicant: SKYKAR INC., Etobicoke (CA)

(72) Inventor: Markus Leng, Warkworth (CA)

(21) Appl. No.: 14/338,959

(22) Filed: Jul. 23, 2014

Related U.S. Application Data
(60) Provisional application No. 61/874,180, filed on Sep. 5, 2013.

(51) Int. Cl. H02K 1/27; H02K 11/00; H02K 1/28

(52) U.S. Cl. CPC H02K 1/2786; H02K 1/28; H02K 1/274; H02K 11/0073
USPC 310/68 D; 310/156.12

(57) ABSTRACT

According to aspects of the present invention there are provided synchronous electric machines including a stationary electromagnetic stator, a rotor having a rotational axis, wherein the rotor includes a cylindrically shaped structure comprising a plurality of concentric layers, and a plurality of permanent magnets disposed on the cylindrical shaped structure.

### CROSS-REFERENCE TO RELATED APPLICATIONS

This application claims the benefit of priority from U.S. Provisional Application Ser. No. 61/874,180 filed Sep. 5, 2013 which is incorporated herein by reference.

### TECHNICAL FIELD

The present invention relates generally to the field of synchronous electric machines, and, more particularly to the field of synchronous electric motors and synchronous electric generators.

### BACKGROUND

Synchronous electric machines include synchronous electric motors and synchronous electric generators.

A brushless electric motor is a synchronous electric motor including a moving rotor and a stationary stator and electronic commutation. There are two common types of brushless electric motor configurations in use. In the outrunner configuration, a rotor with permanent magnets rotates about a stationary electromagnetic stator. In the inrunner configuration, a rotor with permanent magnets rotates within an electromagnetic stationary stator. In both motor configurations, an electrical current is applied to stator windings to make them into electromagnets to drive the rotor.

Synchronous electric motors having an electromagnetic stator and a permanent magnet rotor can generally be operated as generators when the rotor is driven by a mechanical energy input.

The maximum power that can be applied to or generated by a synchronous electric machine, including a brushless electric motor and a brushless electric generator, having an electromagnetic stator and a rotor with permanent magnets, is generally limited by the amount of heat generated by eddy currents. Too much heat weakens the permanent magnets for example.

### SUMMARY

According to one aspect of the present invention there is provided an electromechanical device including a stationary electromagnetic stator, a rotor having a rotational axis, wherein the rotor includes a cylindrically shaped structure comprising a plurality of concentric layers, and a plurality of permanent magnets disposed on the cylindrical shaped structure.

According to another aspect of the present invention there is provided an electronically commutated motor which may be an outrunner brushless DC motor. The motor includes flux rings defined by steel rings with permanent magnets spaced around the inner circumferences of the steel rings and stators inside the rings. In certain embodiments of the present invention, the flux rings are formed using cylindrical laminated steel sections, preferably concentric layers of electric steel bonded together with structural epoxy. In certain embodiments, the permanent magnets may be super magnets.

### DRAWINGS

The invention is described below in greater detail with reference to the accompanying drawings which illustrate preferred embodiments of the invention, and wherein:

FIG. 1 is a diagrammatic end view of an exemplary stator and rotor in accordance with embodiments of the present disclosure;

FIG. 2 is a portion of a FIG. 1 enlarged for magnification purposes;

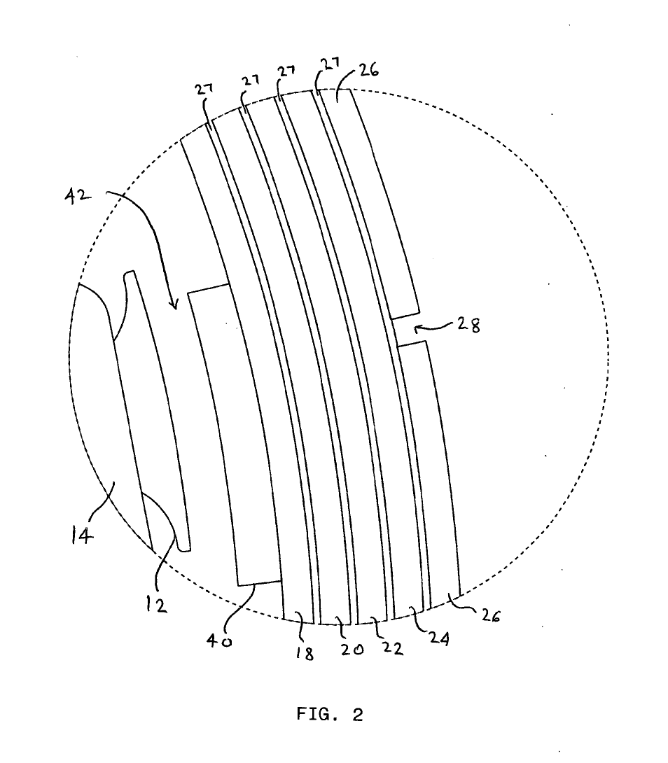

FIG. 3 is a diagrammatic view of an exemplary stator and rotor in accordance with embodiments of the present disclosure

FIG. 4 is a diagrammatic view of an exemplary stator and rotor in accordance with embodiments of the present disclosure;

FIG. 5 is a diagrammatic view of an exemplary stator and rotor in accordance with embodiments of the present disclosure;

FIG. 6 is a diagrammatic end view of an exemplary stator and rotor in accordance with embodiments of the present disclosure;

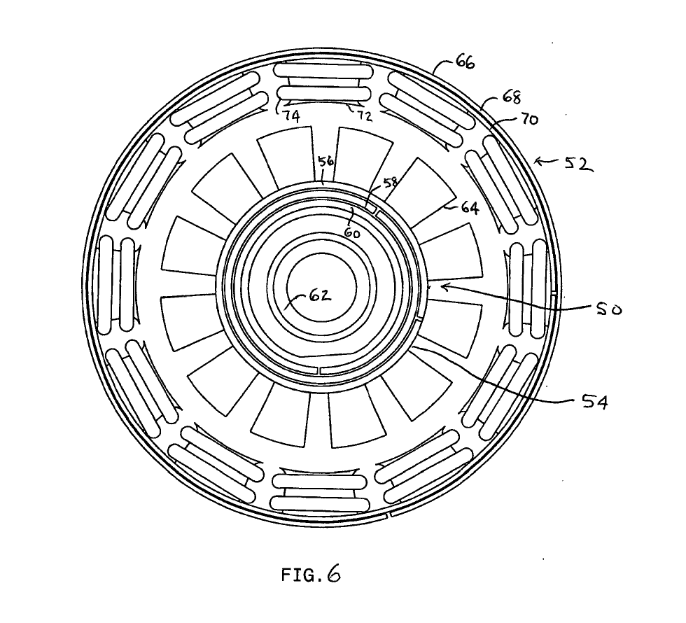

FIG. 7 is a rear perspective view of an exemplary motor in accordance with embodiments of the present disclosure;

FIG. 8 is a front perspective view of the motor of FIG. 7;

FIG. 9 is a partial section of the motor of FIG. 8 taken along 5-5;

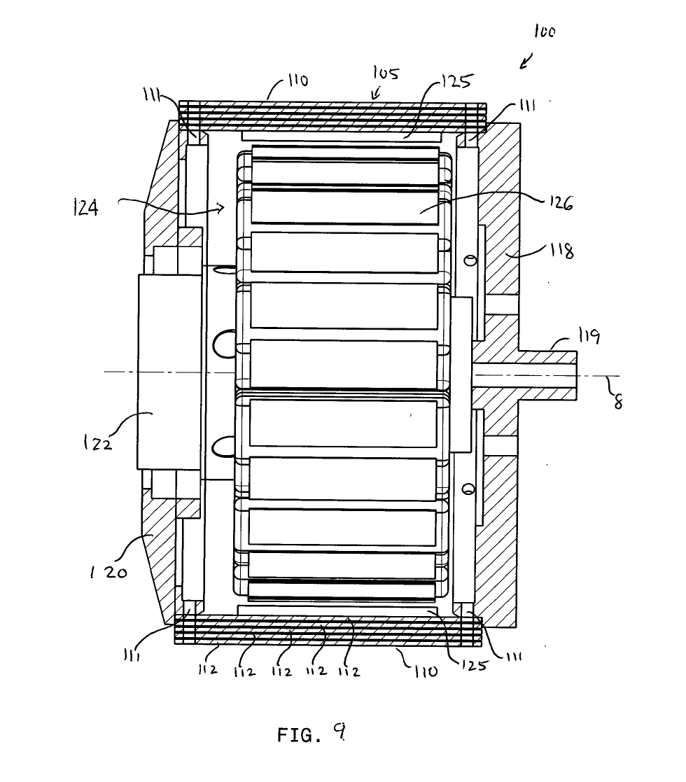

FIG. 10 is a block diagram of an exemplary electric generator set up in accordance with embodiments of the present disclosure; and

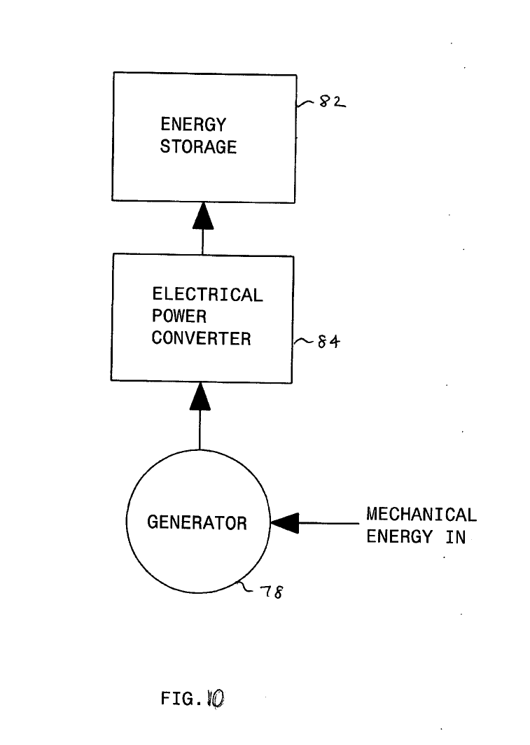

FIG. 11 is a block diagram of an exemplary electric motor set up in accordance with embodiments of the present disclosure.

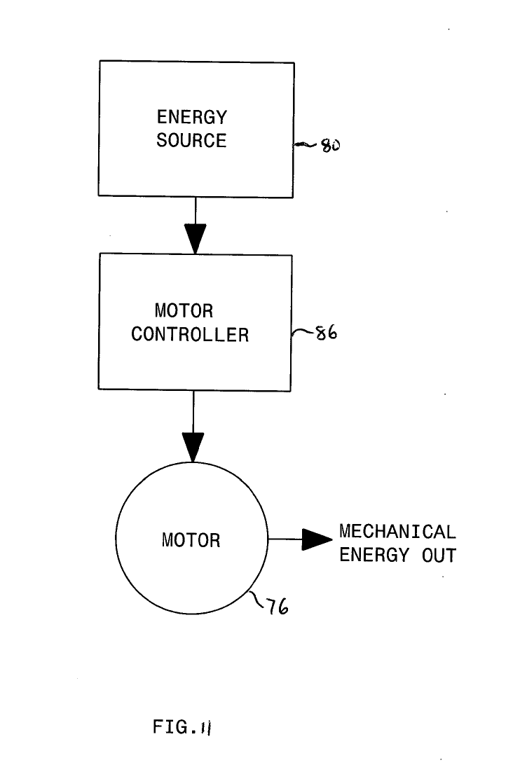

### DETAILED DESCRIPTION

The present invention will now be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein.

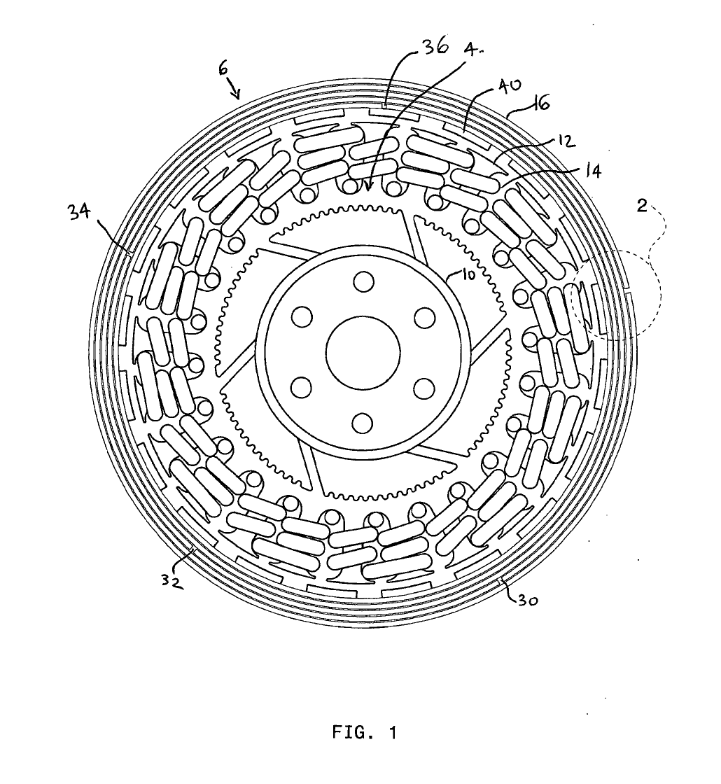

FIG. 1 is a diagrammatic end view of an exemplary stator indicated generally at 4 and a rotor indicated generally at 6 in accordance with certain embodiments of the present disclosure. The stator 4 is an electromagnetic stator and is surrounded by the rotor 6 which is a permanent magnet rotor having a rotational axis 8.

The stator 4 includes a central hub 10 and radially outwardly projecting pole shoes 12 with wire windings 14 about the pole shoes 12. The electrical connections to the windings 14 are not shown. In certain embodiments, of the present invention, the stator 4 may be wound as a conventional three-phase motor with a conventional three lead connection to connect the stator 4 to a motor controller which is connected to an electric energy source. In certain embodiments of the present invention, the stator 4 may also be wound and connected as a generator. Other suitable conventional stators may be used as the stator 4. Novel stator configurations and/or stator windings may also be used.

The permanent magnet rotor 6 includes a cylindrical shaped structure 16 (also sometimes referred to herein as a flux ring) that includes laminated concentric layers 18, 20, 22, 24 and 26. The layers 18, 20, 22, 24 and 26 are made of electric steel. Other suitable electrically conductive materials may be used for the layers 18, 20, 22, 24 and 26. In certain embodiments, the layers 18, 20, 22, 24 and 26 may all include identical materials, or alternating types of materials, or another suitable configuration.

The layers 18, 20, 22, 24 and 26 may be coated with a C5 electrical insulator (not shown). Other non-conductive coatings, such as C1 to C4 or C6 coatings, may be used.

The layers 18, 20, 22, 24 and 26 are bonded together with structural epoxy layers 27. In certain embodiments, the laminated concentric layers of the cylindrical shaped structure 16 may be bonded, coupled or adhered together via one or more layers of other suitable bonding materials. In other embodiments, where the laminated concentric layers are not otherwise electrically insulated, such as via an insulating coating, the bonding material should be non-electrically conducting or minimally electrically conducting. In certain embodiments, the bonding material may be an adhesive which retains a degree of plasticity when cured such that the laminated layers can flex somewhat during use but remain sufficiently bonded together. In certain embodiments, the bonding material may be an epoxy which includes an elastomeric component which imparts flexibility when cured to the laminated layers which enables the laminated layers to flex or deform but still retain sufficient structural integrity.

In other embodiments, the laminated concentric layers of the cylindrical shaped structure 16 may be coupled together by mechanical means such as a bolts 29. Other suitable mechanical fasteners include screws, pins, clamps etc. provided that the layers are sufficiently physically separated, such as by a coating, to sufficiently electrically isolate the layers from each other. In other embodiments, both a bonding material and a mechanical fastener may be used.

The layers 18, 20, 22, 24 and 26 each have a thickness of approximately 15 thousandths of an inch. Other suitable thicknesses may be used for the laminated concentric layers of the cylindrical shaped structure 16, with some or all of the laminated concentric layers being of the same thickness or different thicknesses.

The layers 18, 20, 22, 24 and 26 are each formed of a single sheet of electric steel with seams 28, 30, 32, 34 and 36 where the ends of the sheets meet. The seams 28, 30, 32, 34 and 36 are offset from one another but this is not essential.

In certain embodiments of the present invention, the laminated concentric layers of the cylindrical shaped structure 16 may include a plurality of cylindrical or tubular shaped structures 35 disposed concentrically one after the other in a radial direction relative to the rotational axis 8. In certain embodiments, each laminated concentric layer of the cylindrical shaped structure 16 may include concentric segments 36.

In certain other embodiments, the laminated concentric layers of the cylindrical shaped structure 16 may include a single continuous strip 38 of material wound successively about the rotational axis 8.

The cylindrical shaped structure 16 must include at least two laminated concentric layers. In further embodiments, the cylindrical shaped structure 16 may include more than two laminated layers, such as three, four, five, six or more layers.

A plurality of magnets 40 lines the inside of the cylindrical shaped structure 16. The magnets 40 are permanent types primarily made from rare earth materials, such as neodymium, samarium cobalt or similar material. The number of magnets 40 varies with a particular application, but is always a multiple of two. The magnets 40 are arranged with alternating pole orientation, north, south, north, south; and so on. The permanent magnet rotor 6 rotates in close proximity to stator 4, separated by a continuous separating air gap 42 that permits the rotor 6 to rotate freely in close proximity to electromagnetic stator 4 without contact.

In another embodiment of the present invention, the brushless DC electric motor generally is an inrunner type and includes a permanent magnet rotor 50 surrounded by an electromagnetic stator 52.

In one embodiment, the permanent magnet rotor 50 includes a cylindrical shaped structure 54 that includes three laminated concentric layers 56, 58 and 60. The cylindrical shaped structure 54, including the layers 56, 58 and 60, may comprise configurations according to the teachings herein with respect to the laminated concentric layers of the cylindrical shaped structure 16. The rotor 50 includes a central hub 62 and permanent magnets 64 arranged around the outside of the cylindrical shaped structure 16.

The stator 52 includes a cylindrical shaped structure 66 which includes two concentric laminated layers 68 and 70 and in certain embodiments, may comprise configurations according to the teachings herein with respect to the laminated concentric layers of the cylindrical shaped structure 16 or may be formed of a single unlaminated layer.

The stator 52 includes radially inwardly projecting pole shoes 72 with wire windings 74 around the shoes 72. A conventional stator may be used for the stator 52.

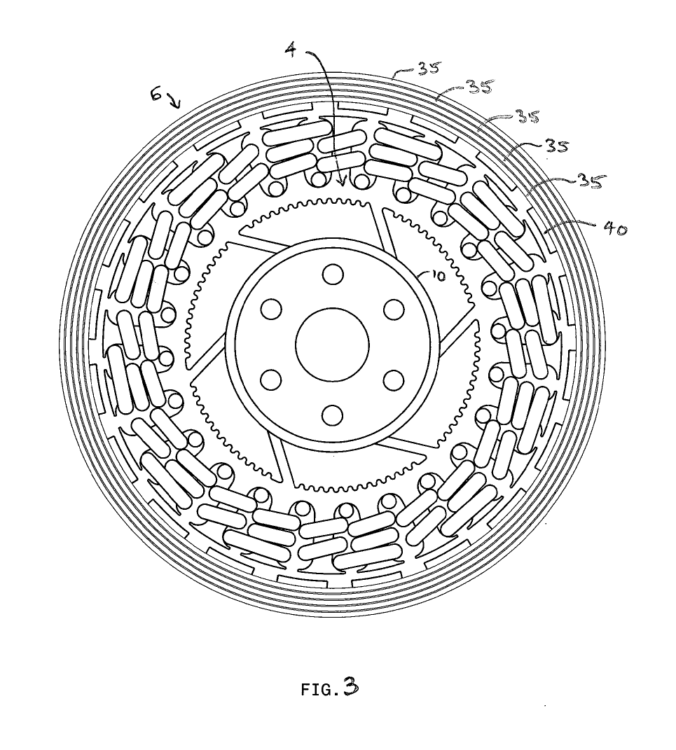

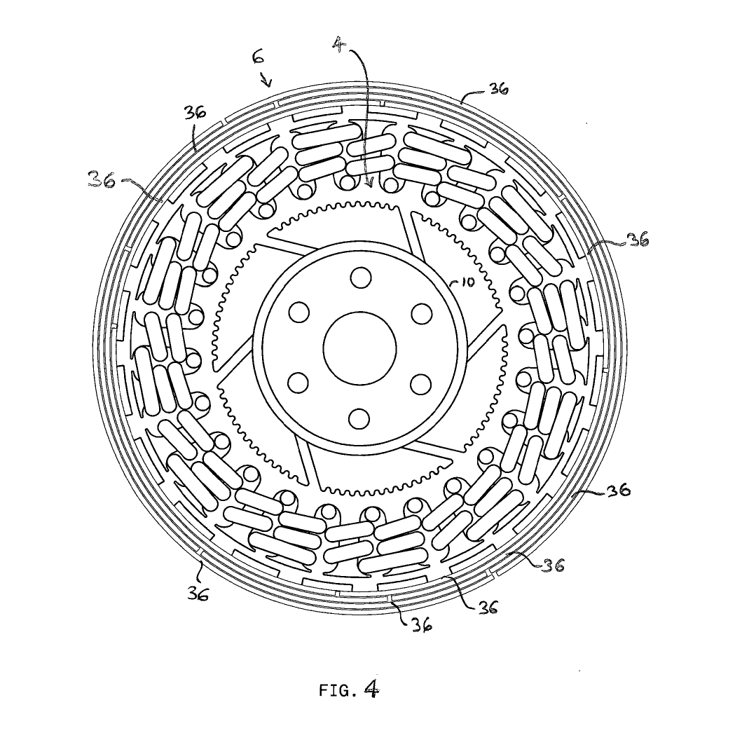

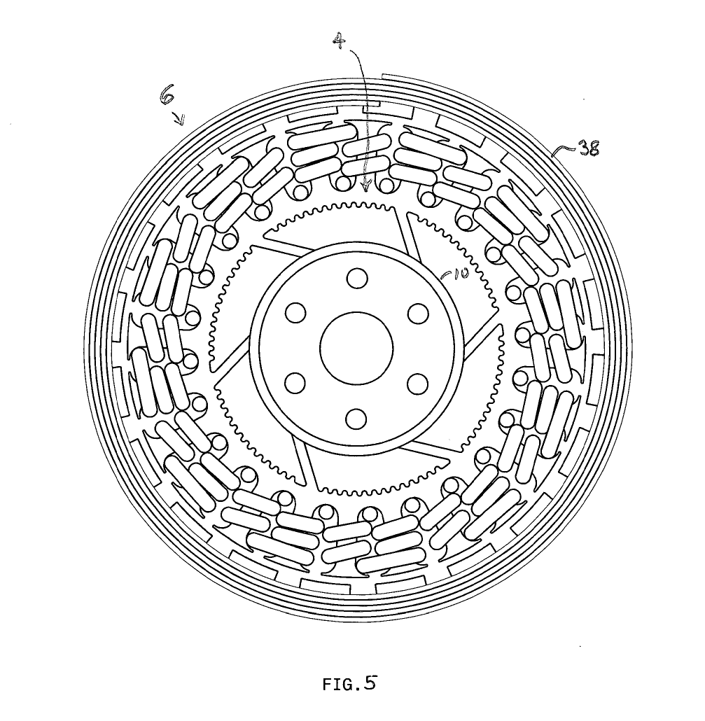

In certain embodiments of the present invention, a motor or generator may include a rotor having laminated concentric layers according to embodiments of the present invention. An exemplary motor including a rotor having laminated concentric layers is indicated generally at 100 in FIGS. 3-5. The motor 100 includes a rotor indicated generally at 105 which includes the cylindrical shaped structure 110 having five laminated layers 112 according to the embodiment described herein with respect to layers 18, 20, 22, 24 and 26. It will be understood that the cylindrical shaped structure 110 may have layers according to other embodiments of the present invention, such as the embodiments illustrated in FIGS. 3 to 5.

Rotor end caps 114 and 116 are provided and secured to the cylindrical shaped structure 110 by bolts 29 in holes 111. End plate 114 with web 118 is provided on the front end of the motor 100 and end plate 116 with web 120 is provided on the rear end of the motor 100. The web plate 118 includes a shaft 119 to which a propeller, axle etc. to be driven may be attached

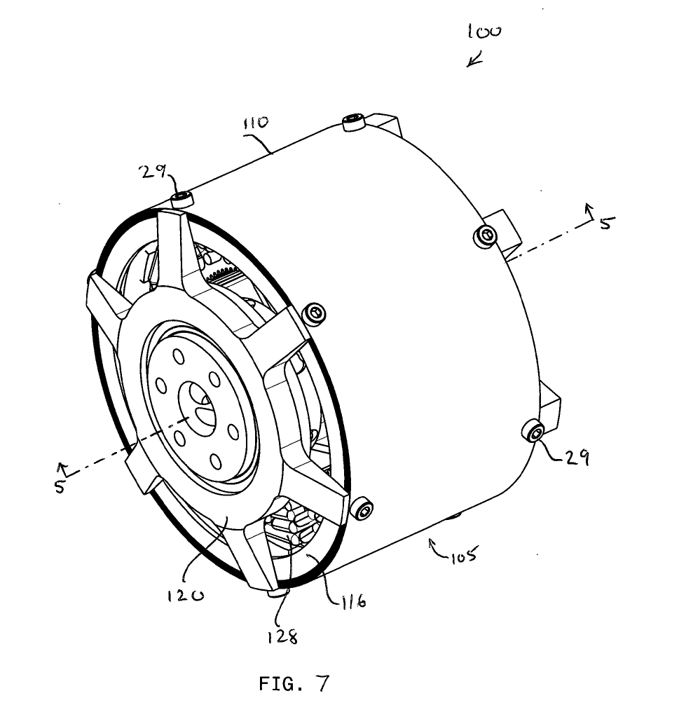

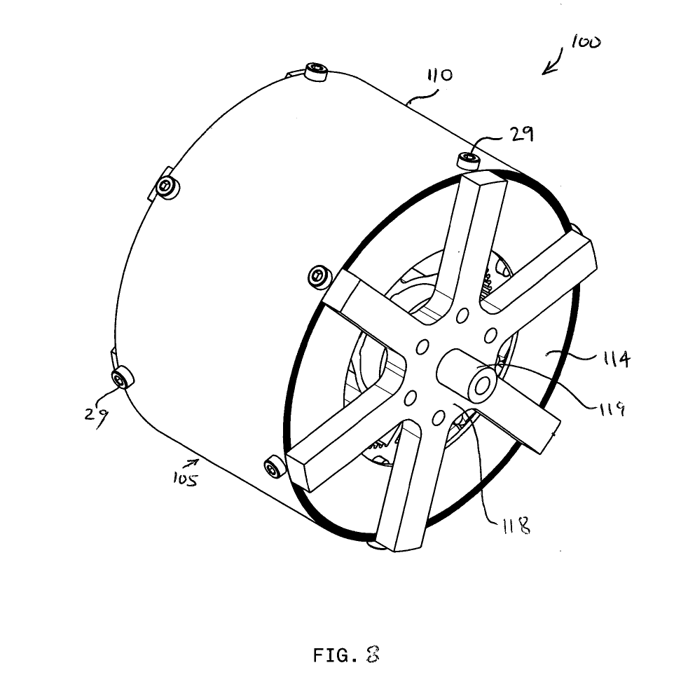

The end plates 118 and 120 connect the rotor 105 to the hub 122 of the stator indicated generally at 124. The rotor 105 includes a plurality of permanent magnets 125. The stator 124 is an electromagnetic stator including pole shoes 126 with windings 128. The windings are not shown in FIGS. 7 and 8 for simplicity.

Without being bound by theory, the inventor believes that concentric layering of the cylindrical structure of the rotor reduces the size of eddy currents in the rotor and as a result, less heat is generated.

In certain embodiments, a rotor with concentric layering according to embodiments of the present invention may be used as part of an otherwise conventional electromechanical device, including synchronous electric motors and generators, including in otherwise conventional brushless DC motors and generators of outrunner or inrunner configurations.

In certain embodiments, a rotor with concentric layering according to embodiments of the present invention may be disposed in a motor 76 or generator 78 which includes otherwise conventional components known to persons skilled in the art such as one or more of a power source, such as energy source 80, an energy storage 82, an electrical power converter 84, and a controller, such as motor controller 86, for electronically controlling the motor 76, such as by controlling motor position and/or rotational speed, and may be disposed in a motor or generator including in a power system, a vehicle, an automobile, a bus, an aircraft, a watercraft, or other suitable vehicle, and a non-vehicle application.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

I claim:

1. A synchronous electric machine comprising:
stationary electromagnetic stator,
a rotor having a rotational axis, wherein the rotor comprises:
a cylindrically shaped structure comprising a plurality of concentric layers, and,
a plurality of permanent magnets disposed on the cylindrical shaped structure.

2. The synchronous electric machine of claim 1, wherein the concentric layers are disposed one after the other in a radial direction relative to the rotational axis.

3. The synchronous electric machine of claim 1, wherein at least one of the concentric layers has a substantially tubular geometry.

4. The synchronous electric machine of claim 1, wherein at least one of the concentric layers comprises a plurality of concentric segments.

5. The synchronous electric machine of claim 1, wherein the plurality of concentric layers comprise a single continuous strip of material wound successively about the rotational axis.

6. The synchronous electric machine of claim 1, wherein the plurality of concentric layers are laminated.

7. The synchronous electric machine of claim 6, wherein the plurality of concentric layers are bonded together with an adhesive.

8. The synchronous electric machine of claim 7, wherein the adhesive comprises an elastomeric component which imparts a flexibility to the laminated layers.

9. The synchronous electric machine of claim 6, wherein the plurality of concentric layers are coupled together with a mechanical fastener.

10. The synchronous electric machine of claim 1, wherein the machine is a motor having the rotor and the stator of claim 1.

11. The synchronous electric machine of claim 1, wherein the machine is a generator having the rotor and the stator of claim 1.

12. The synchronous electric machine of claim 1, wherein the rotor is disposed about the stator.

13. The synchronous electric machine of claim 1, wherein the stator is disposed about the rotor.

14. The synchronous electric machine of claim 12, further comprising a controller for electronically commutating the machine.

15. The synchronous electric machine of claim 13, further comprising a controller for electronically commutating the device.

16. An electronically commutated motor comprising:
a rotor comprising:
flux rings defined by rings with permanent magnets spaced around the inner circumference of the rings, and
a stator inside the rings.

17. The electronically commutated motor of claim 16, wherein the flux rings are formed using cylindrical laminated steel sections.

18. The electronically commutated motor of claim 17, wherein the cylindrical laminated steel sections comprise concentric layers of electric steel bonded together with an adhesive.

19. The electronically commutated motor of claim 18, wherein the adhesive is sufficiently flexible to accommodate expansion and contraction of the laminated steel sections while maintaining the bonding of the concentric layers.

19. The electronically commutated motor of claim 18 comprising an outrunner brushless motor having the stator and the rotor.
